(19) United States
(12) Patent Application Publication
(10) Pub. No.: US 2024/0322345 A1
(43) Pub. Date: Sep. 26, 2024

(54) TRACTION BATTERY PACK CELL BLOCK ASSEMBLIES THAT EXCLUDE CELL-TO-CELL SPACERS

(71) Applicant: FORD GLOBAL TECHNOLOGIES, LLC, Dearborn, MI (US)

(72) Inventors: Hari Krishna Addanki, Novi, MI (US); Steve Droste, Canton, MI (US); Daniel Benjamin Kok, Ann Arbor, MI (US); Kevin A. Montgomery, Royal Oak, MI (US)

(21) Appl. No.: 18/506,289

(22) Filed: Nov. 10, 2023

Related U.S. Application Data
(60) Provisional application No. 63/453,240, filed on Mar. 20, 2023.

(51) Int. Cl. H01M 50/291; H01M 10/625; H01M 10/647; H01M 10/6554; H01M 50/209; H01M 50/249; H01M 50/507

(52) U.S. Cl. CPC H01M 50/291; H01M 10/625; H01M 10/647; H01M 10/6554; H01M 50/209; H01M 50/249; H01M 50/507; H01M 2220/20

(57) ABSTRACT

“Spacerless” cell block assemblies are provided for traction battery packs. Exemplary cell block assemblies may include a battery cell grouping, a bus bar module, and a heat exchanger plate. The battery cell grouping may be arranged between the bus bar module and the heat exchanger plate. The bus bar module may provide first spacer features, and the heat exchanger plate may provide second spacer features. The first and second spacer features cooperate to maintain air gaps between adjacent battery cells of the battery cell grouping.

### CROSS REFERENCE TO RELATED APPLICATION

This application claims priority to U.S. Provisional Application No. 63/453,240, which was filed on Mar. 20, 2023 and is incorporated herein by reference.

### TECHNICAL FIELD

This disclosure relates generally to electrified vehicle traction battery packs, and more particularly to a cell block assembly that excludes individual battery cell-to-battery cell spacers for filing air gaps between battery cells.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A cell block assembly for a traction battery pack according to an exemplary aspect of the present disclosure includes, among other things, a battery cell grouping, an upper assembly structure including a first spacer feature, and a lower assembly structure including a second spacer feature. The first spacer feature and the second spacer feature cooperate to establish an air gap between adjacent battery cells of the battery cell grouping.

In a further non-limiting embodiment of the foregoing cell block assembly, the upper assembly structure is a bus bar module, and the lower assembly structure is a heat exchanger plate.

In a further non-limiting embodiment of either of the foregoing cell block assemblies, the first spacer feature protrudes downwardly from a frame of the bus bar module, and the second spacer feature protrudes upwardly from a top surface of the heat exchanger plate.

In a further non-limiting embodiment of any of the foregoing cell block assemblies, the first spacer feature is configured as a cross-shaped rib.

In a further non-limiting embodiment of any of the foregoing cell block assemblies, the second spacer feature is configured as an elongated rib.

In a further non-limiting embodiment of any of the foregoing cell block assemblies, the elongated rib extends extend across a majority of a length of the lower assembly structure.

In a further non-limiting embodiment of any of the foregoing cell block assemblies, the first spacer feature aligns with and fills spaces between corners of the adjacent battery cells.

In a further non-limiting embodiment of any of the foregoing cell block assemblies, the second spacer feature aligns with and fills spaces between corners of the adjacent battery cells.

In a further non-limiting embodiment of any of the foregoing cell block assemblies, the battery cell grouping includes at least two rows of battery cells.

In a further non-limiting embodiment of any of the foregoing cell block assemblies, the air gap extends between short sides of the adjacent battery cells, long sides of the adjacent battery cells, or both.

A traction battery pack according to another exemplary aspect of the present disclosure includes, among other things, a cell block assembly including a battery cell grouping that includes at least a first battery cell and a second battery cell, a bus bar module including a first spacer feature, and a heat exchanger plate including a second spacer feature. The first spacer feature and the second spacer feature cooperate to maintain an air gap between the first battery cell and the second battery cell.

In a further non-limiting embodiment of the foregoing traction battery pack, the first spacer feature is configured as a cross-shaped rib.

In a further non-limiting embodiment of either of the foregoing traction battery packs, the second spacer feature is configured as an elongated rib.

In a further non-limiting embodiment of any of the foregoing traction battery packs, the elongated rib extends extend across a majority of a length of the heat exchanger plate.

In a further non-limiting embodiment of any of the foregoing traction battery packs, the air gap extends between short sides of the first and second battery cells, long sides of the first and second battery cells, or both.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded view of a cell block assembly for a traction battery pack.

FIG. 3 illustrates a bus bar module of the cell block assembly of FIG. 2.

FIG. 4 illustrates a heat exchanger plate of the cell block assembly of FIG. 2.

FIG. 5 is a first cross-sectional view of the cell block assembly of FIG. 2. The first cross-sectional view is taken along a length of battery cells of the cell block assembly.

FIG. 6 is a second cross-sectional view of the cell block assembly of FIG. 2. The second cross-sectional view is taken along a width of battery cells of the cell block assembly.

### DETAILED DESCRIPTION

This disclosure details exemplary “spacerless” cell block assemblies for traction battery packs. Exemplary cell block assemblies may include a battery cell grouping, a bus bar module, and a heat exchanger plate. The battery cell grouping may be arranged between the bus bar module and the heat exchanger plate. The bus bar module may provide first spacer features, and the heat exchanger plate may provide second spacer features. The first and second spacer features may cooperate to maintain air gaps between adjacent battery cells of the battery cell grouping. These and other features are discussed in greater detail in the following paragraphs of this detailed description.

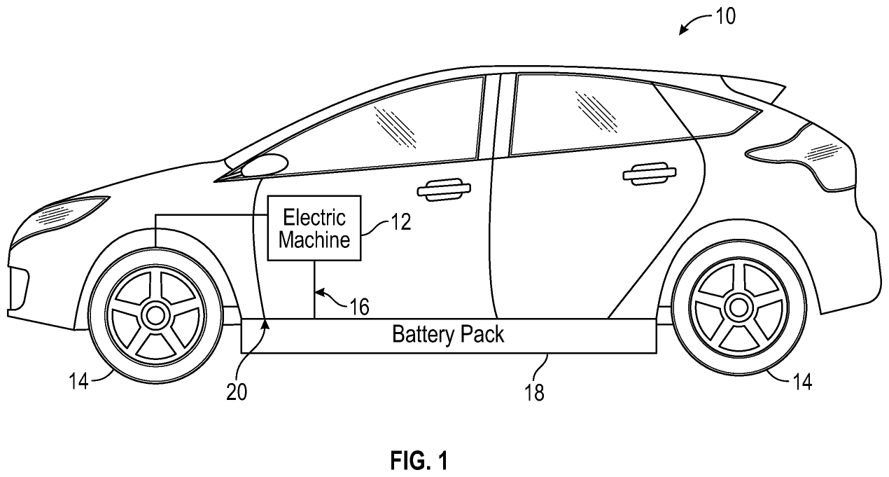

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In an embodiment, the electrified vehicle 10 is a full electric vehicle propelled solely through electric power, such as by one or more electric machines 12, without any assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

In prior traction battery pack designs, individual spacer plates are typically required to fill the spaces between adjacent battery cells of the traction battery pack 18 and help manage battery cell expansion forces. These spacer plates increase the complexity and assembly time of the traction battery pack. This disclosure is therefore directed to traction battery packs that provide “spacerless” battery cell groupings in which spacer features are integrated into other battery components to create an air gap between the battery cells and eliminate the need for dedicated individual spacer plates.

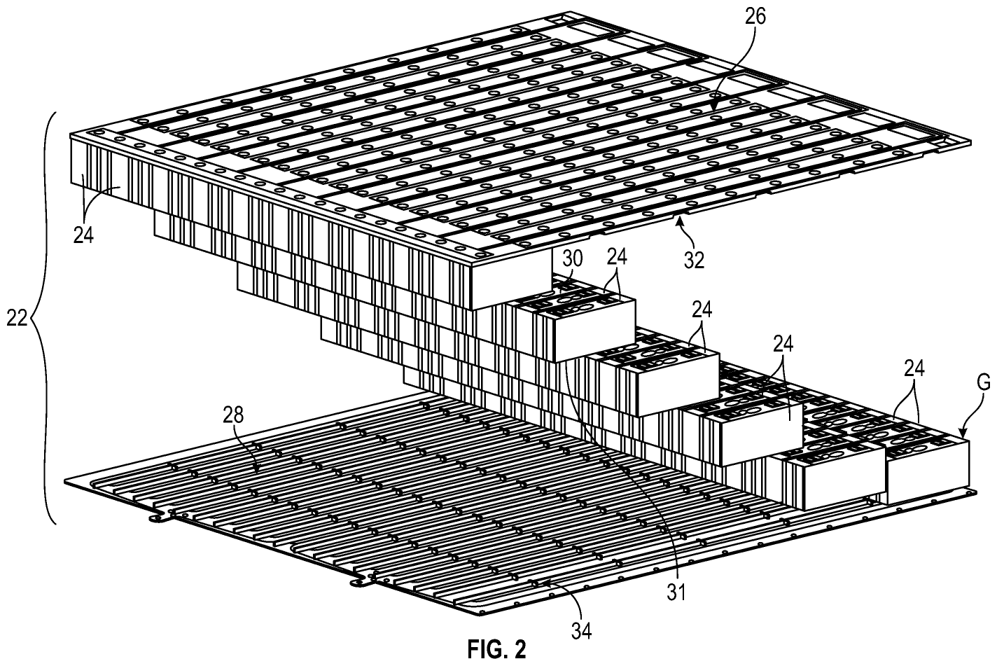

FIG. 2 illustrates an exemplary cell block assembly 22 for a traction battery pack, such as the traction battery pack 18 of the electrified vehicle 10 of FIG. 1, for example. As explained in further detail below, the cell block assembly 22 may eliminate the need for dedicated individual battery cell spacer plates by incorporating spacer features into other components of the cell block assembly 22. Although not shown in the highly schematic depiction of FIG. 2, the cell block assembly 22 may be housed within an interior area of an outer enclosure assembly of the traction battery pack 18.

The cell block assembly 22 may include a plurality of battery cells 24. The battery cells 24 may be arranged together in a large format battery cell grouping G, which may be referred to as a cell matrix or cell grid. The battery cell grouping G may include two or more rows of battery cells 24. The total number of battery cells 24 and rows provided within the cell block assembly 22 can vary and are not intended to limit this disclosure.

In an embodiment, the battery cells 24 are prismatic, lithium-ion cells. However, battery cells having other geometries (cylindrical, pouch, etc.) and/or chemistries (nickel-metal hydride, lead-acid, etc.) could alternatively be utilized within the scope of this disclosure.

The cell block assembly 22 may further include a bus bar module 26 and a heat exchanger plate 28 The bus bar module 26 may be arranged to extend in span across top surfaces 30 (e.g., terminal sides) of the battery cells 24, and the heat exchanger plate 28 may be arranged to extend in span below bottom surfaces 31 (e.g., non-terminal sides) of the battery cells 24. The bus bar module 26 may thus establish an upper assembly structure of the cell block assembly 22, and the heat exchanger plate 28 may establish a lower assembly structure of the cell block assembly 22. However, other configurations are also contemplated within the scope of this disclosure.

The bus bar module 26 may be arranged to electrically connect the battery cells 24. Once electrically coupled, the battery cells 24 may supply electrical power for powering various components of the electrified vehicle 10 for supporting electric propulsion.

The heat exchanger plate 28 may be arranged to function as a liquid cooled “cold plate” of the cell block assembly 22. For example, the heat exchanger plate 28 may be part of a liquid cooling system that is configured for circulating a coolant, such as water mixed with ethylene glycol or any other suitable coolant, through an interior cooling circuit of the heat exchanger plate 28. The coolant may pick up heat that is generated within the battery cells 24 as it circulates through the internal cooling circuit. Although not shown, a thermal interface material (e.g., epoxy resin, silicone based materials, thermal greases, etc.) could be disposed between the battery cells 24 and the heat exchanger plate 28 for facilitating heat transfer therebetween.

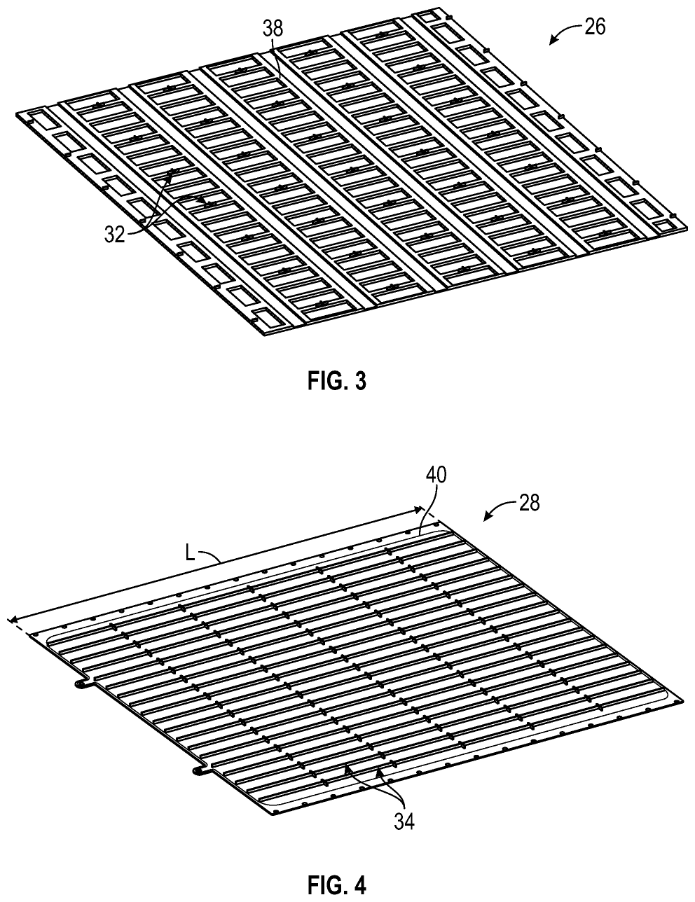

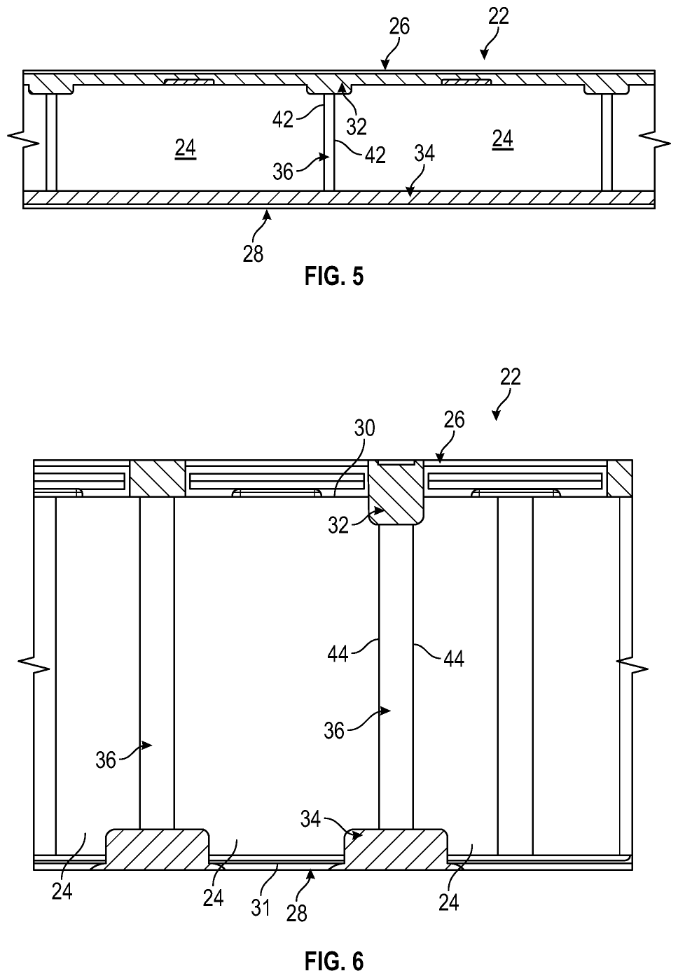

Referring now to FIGS. 2, 3, 4, 5, and 6, the bus bar module 26 may include a plurality of first spacer features 32, and the heat exchanger plate 28 may include a plurality of second spacer features 34. The first spacer features 32 and the second spacer features 34 may cooperate to separate the battery cells 24 of the battery cell grouping G from one another and establish an air gap 36 (best shown in FIGS. 5 and 6) between adjacent battery cells 24 of the cell block assembly 22. The first and second spacer features 32, 34 therefore eliminate the need to provide dedicated individual spacer plates between the battery cells 24 of the cell block assembly 22.

The first spacer features 32 may protrude outwardly from a frame 38 of the bus bar module 26. The first spacer features 32 may extend downwardly to partially fill the space between the battery cells 24 of the battery cell grouping G. The first spacer features 32 may be arranged on the frame 38 such that, when the bus bar module 26 is received over the battery cell grouping G, the first spacer features 32 align with and fill the spaces between corners of the battery cells 24. The first spacer features 32 may be molded features of the frame 38.

In an embodiment, the first spacer features 32 are configured as cross-shaped ribs. However, other configurations are contemplated within the scope of this disclosure.

The second spacer features 34 may protrude outwardly from a top surface 40 of the heat exchanger plate 28. The second spacer features 34 may extend upwardly to partially fill the space between the battery cells 24. The second spacer features 34 may be arranged on the top surface 40 such that, when the battery cell grouping G is positioned near or against the heat exchanger plate 28, the second spacer features 34 align with and fill the spaces between corners of the battery cells 24.

In an embodiment, the second spacer features 34 are configured as elongated ribs that extend across a majority of a length L of the heat exchanger plate 28. However, other configurations are contemplated within the scope of this disclosure.

Together, the first spacer features 32 and the second spacer features 34 keep the battery cells 24 separated with the air gap 36 therebetween. The air gap 36 may be maintained between short sides 42 of the battery cells 24 (see FIG. 5) and/or between long sides 44 of the battery cells 24 (see FIG. 6).

The exemplary cell block assemblies of this disclosure are designed to integrate battery cell spacer features into other battery components and thereby eliminate the need for dedicated individual battery cell spacer plates. Among other benefits, the proposed “spacerless” design reduces complexity and assembly time.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A cell block assembly for a traction battery pack, comprising:
a battery cell grouping;
an upper assembly structure including a first spacer feature; and
a lower assembly structure including a second spacer feature,
wherein the first spacer feature and the second spacer feature cooperate to establish an air gap between adjacent battery cells of the battery cell grouping.

2. The cell block assembly as recited in claim 1, where the upper assembly structure is a bus bar module, and the lower assembly structure is a heat exchanger plate.

3. The cell block assembly as recited in claim 2, where the first spacer feature protrudes downwardly from a frame of the bus bar module, and the second spacer feature protrudes upwardly from a top surface of the heat exchanger plate.

4. The cell block assembly as recited in claim 1, wherein the first spacer feature is configured as a cross-shaped rib.

5. The cell block assembly as recited in claim 1, wherein the second spacer feature is configured as an elongated rib.

6. The cell block assembly as recited in claim 5, wherein the elongated rib extends extend across a majority of a length of the lower assembly structure.

7. The cell block assembly as recited in claim 1, wherein the first spacer feature aligns with and fills spaces between corners of the adjacent battery cells.

8. The cell block assembly as recited in claim 1, wherein the second spacer feature aligns with and fills spaces between corners of the adjacent battery cells.

9. The cell block assembly as recited in claim 1, wherein the battery cell grouping includes at least two rows of battery cells.

10. The cell block assembly as recited in claim 1, wherein the air gap extends between short sides of the adjacent battery cells, long sides of the adjacent battery cells, or both,

11. A traction battery pack, comprising:
a cell block assembly comprising:
a battery cell grouping including at least a first battery cell and a second battery cell;
a bus bar module including a first spacer feature; and
a heat exchanger plate including a second spacer feature,
wherein the first spacer feature and the second spacer feature cooperate to maintain an air gap between the first battery cell and the second battery cell.

12. The traction battery pack as recited in claim 11, wherein the first spacer feature is configured as a cross-shaped rib.

13. The traction battery pack as recited in claim 11, wherein the second spacer feature is configured as an elongated rib.

14. The traction battery pack as recited in claim 13, wherein the elongated rib extends extend across a majority of a length of the heat exchanger plate.

15. The traction battery pack as recited in claim 11, wherein the air gap extends between short sides of the first and second battery cells, long sides of the first and second battery cells, or both.
